(19) United States
(12) Patent Application Publication
(10) Pub. No.: US 2017/0300140 A1
(43) Pub. Date: Oct. 19, 2017

(54) TOUCH DISPLAY PANEL, METHOD FOR FABRICATION THEREOF AND TOUCH DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventors: Changdi CHEN, Beijing (CN); Tao YANG, Beijing (CN); Yiyong LUO, Beijing (CN)

(73) Assignees: BOE TECHNOLOGY GROUP CO., LTD., Beijing (CN); HEFEI BOE OPTOELECTRONICS TECHNOLOGY CO., LTD., Hefei (CN)

(21) Appl. No.: 15/512,606

(22) PCT Filed: Feb. 18, 2016
(86) PCT No.: PCT/CN2016/074010

§ 371 Date: Mar. 20, 2017

(30) Foreign Application Priority Data
Mar. 19, 2015 (CN) 201510124542.4

(51) Int. Cl. G06F 3/041

(52) U.S. Cl. CPC G06F 3/041; G06F 2203/04103

(57) ABSTRACT

The embodiments of the disclosure disclose a touch display panel including a touch substrate, a first display substrate, and a second display substrate, wherein the touch substrate, the first display substrate, and the second display substrate are sequentially arranged, and an elastic buffer layer is provided between the first display substrate and the touch substrate. When the touch display panel according to embodiments of the disclosure is pressed by the external force, the elastic buffer layer is able to release the external force in a way of shape change such that the impact of the external forces on the touch display panel can be avoided or mitigated and the anti-pressure ability of the touch display panel can be enhanced.

### CROSS REFERENCE TO RELATED APPLICATIONS

This application is a National Stage Entry of PCT/CN2016/074010 filed Feb. 18, 2016, which claims the benefit and priority of Chinese Patent Application No. 201510124542.4, filed on Mar. 19, 2015, the disclosures of which are incorporated by reference herein in their entirety as a part of the present application.

### BACKGROUND

The embodiments of the disclosure relate to touch display panels, methods for fabrication thereof, and touch display devices.

Touch screen display can let users use their fingers to touch an icon or text on the touch screen display in order to implement host operations, such that the keyboard and mouse operations can be get rid of and man-machine interaction become simpler. The touch screen display has become a mainstream display device currently.

However the anti-pressure ability of the touch display panel in the prior art is poor and easy to damage when pressed by an external force, therefore the lifetime of the touch display panel is reduced, i.e., the normal use of the touch screen display is affected. Therefore, it is desirable to provide an improved touch display panel, a method for fabrication thereof, and a touch display device.

### BRIEF DESCRIPTION

The embodiments of the disclosure provide a touch display panel, a method for fabrication thereof, and a touch display device.

A first aspect of the disclosure provides a touch display panel including a touch substrate, a first display substrate, and a second display substrate, wherein the touch substrate, the first display substrate, and the second display substrate are sequentially arranged, and an elastic buffer layer is provided between the first display substrate and the touch substrate.

According to an embodiment of the disclosure, an optically clear adhesive layer or an optically clear resin layer is provided between the touch substrate and the elastic buffer layer.

According to an embodiment of the disclosure, the elastic buffer layer is provided on the first display substrate.

According to an embodiment of the disclosure, the materials of the elastic buffer layer are resin.

According to an embodiment of the disclosure, spacers are provided between the first display substrate and the second display substrate, and the materials of the elastic buffer layer and the materials of the spacers are the same.

According to an embodiment of the disclosure, the end faces that the spacers contact the first display substrate and the second display substrate are arcing structures.

According to an embodiment of the disclosure, the spacers are provided on the second display substrate, the spacers and the second display substrate are integrated together, and the ends that the spacers contact the first display substrate are arcing structures.

According to an embodiment of the disclosure, the first display substrate is a color film substrate, the second display substrate is an array substrate, and the first display substrate and the second display substrate are arranged to form a cell.

According to an embodiment of the disclosure, the touch substrate is a one-glass-solution touch substrate.

A second aspect of the disclosure provides a touch display device including the above touch display panel.

A third aspect of the disclosure provides a method for fabricating a touch display panel. The method includes performing a cell process for a first display substrate and a second display substrate, providing an elastic buffer layer at a surface of the first display substrate far away from the second display substrate, and laminating a touch substrate with the first display substrate.

According to an embodiment of the disclosure, laminating the touch substrate with the first display substrate includes coating optically clear adhesive or optically clear resin on a surface of the elastic buffer layer and then laminating the touch substrate on it.

According to an embodiment of the disclosure, providing the elastic buffer layer at the surface of the first display substrate far away from the second display substrate includes coating the materials of the elastic buffer layer on a surface of the first display substrate far away from the second display substrate.

According to an embodiment of the disclosure, the materials of the elastic buffer layer are resin.

The touch display panel according to embodiments of the disclosure can enhance greatly the anti-pressure ability of the touch display panel and increase the lifetime of the touch display panel by providing the elastic buffer layer between the first display substrate and the touch substrate such that when the touch display panel is pressed by the external force, the elastic buffer layer next to the touch substrate is pressed by the external force, the elastic buffer layer is deformed under the action of the external force, and then the external force can be released.

### BRIEF DESCRIPTION OF THE DRAWINGS

In order to illustrate the technique solution of embodiments of the present disclosure more clearly, the accompanying drawings will hereinafter be introduced briefly. It is obvious that the accompanying drawings in the following description are only related to some embodiments of the present disclosure and should not be construed as restriction on the present disclosure.

FIG. 1 shows a schematic structure diagram of a touch display panel according to an embodiment of the disclosure;

FIG. 2 shows a schematic structure diagram of a touch display panel according to another embodiment of the disclosure;

FIG. 3 shows a schematic structure diagram of a touch display panel according to another embodiment of the disclosure;

FIG. 4 shows a schematic structure diagram of a touch display panel according to another embodiment of the disclosure; and

FIG. 5 is a flow chart of a method for fabricating a touch display panel according to an embodiment of the disclosure.

### DETAILED DESCRIPTION

To make the technical solutions and advantages of embodiments of the present disclosure more clear, the technical solutions of embodiments of the present disclosure will be described below clearly and completely in connection with the accompanying drawings of embodiments of the present disclosure. It is obvious that the described embodiments are some, but not all the embodiments of the present disclosure. Based on the embodiments of the disclosure, all the other embodiments made by those of ordinary skill in the art without the premise of creative work belong to the protection scope of the disclosure.

### Embodiment 1

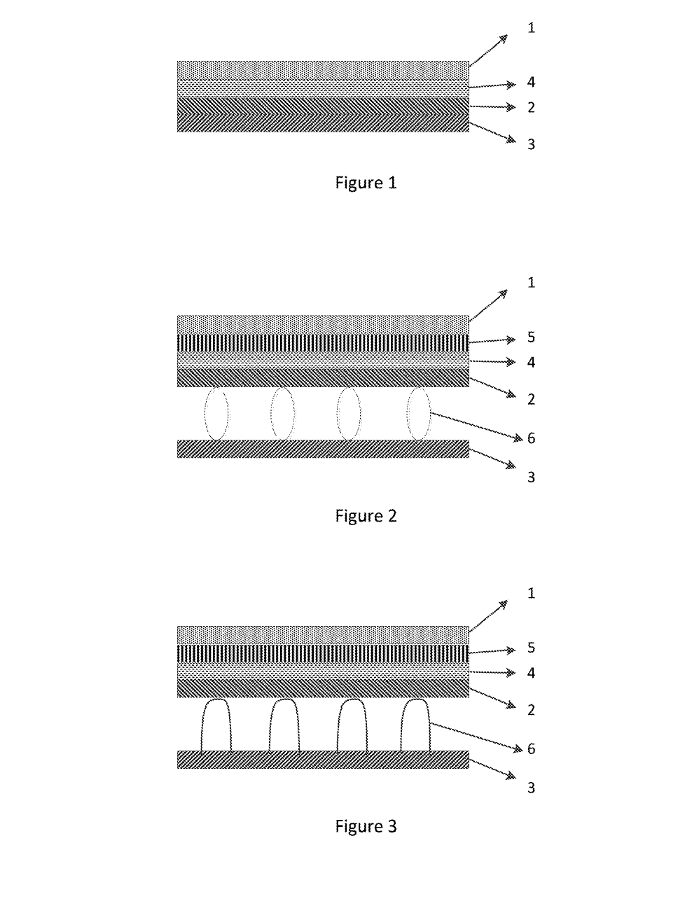

FIG. 1 shows a schematic structure diagram of a touch display panel according to embodiment 1. As shown in FIG. 1, the touch display panel according to embodiment 1 includes a touch substrate 1, a first display substrate 2, and a second display substrate 3, wherein the touch substrate 1, the first display substrate 2, and the second display substrate 3 are sequentially arranged, and an elastic buffer layer 4 is provided between the first display substrate 2 and the touch substrate 1.

Specifically, the elastic buffer layer 4 may be provided on the first display substrate 2 or under the touch substrate 1.

The touch display panel according to the embodiment can enhance greatly the anti-pressure ability of the touch display panel and increase the lifetime of the touch display panel by providing the elastic buffer layer 4 between the touch substrate 1 and the first display substrate 2 such that when the touch display panel is pressed by the external force, the elastic buffer layer 4 next to the touch substrate 1 is pressed by the external force, the elastic buffer layer 4 is deformed under the action of the external force, and then the external force can be released.

### Embodiment 2

FIG. 2 shows a schematic structure diagram of a touch display panel according to embodiment 2. As shown in FIG. 2, the touch display panel according to embodiment 2 includes a touch substrate 1, a first display substrate 2, and a second display substrate 3, wherein the touch substrate 1, the first display substrate 2, and the second display substrate 3 are sequentially arranged, and an elastic buffer layer 4 is provided between the first display substrate 2 and the touch substrate 1. The elastic buffer layer 4 is provided on the first display substrate 2. An optically clear adhesive (OCA) layer 5 or an optically clear resin (OCR) layer 5 is provided between the touch substrate 1 and the elastic buffer layer 4. The elastic buffer layer 4 is laminated with the touch substrate 1 by the optically clear adhesive layer or the optically clear resin layer.

In the embodiment, spacers 6 are provided between the first display substrate 2 and the second display substrate 3, and the materials of the elastic buffer layer 4 and the materials of the spacers 6 are the same.

Spacers 6 provided between the first display substrate 2 and the second display substrate 3 can maintain a constant spacing between the first display substrate 2 and the second display substrate 3 on the one hand and have the anti-pressure and buffering effect and increase the anti-pressure ability of the touch display panel to some extend on the other hand.

In the embodiment, the materials of the elastic buffer layer and the materials of the spacers are the same. On the one hand, it can reduce the complexity of process for manufacturing the touch display panel. On the other hand, since both the spacers and the elastic buffer layer have the anti-pressure and buffering effect, the spacers and the elastic buffer layer adopting the same materials can cause that the spacers and the elastic buffer layer are able to have a uniform buffering effect when the touch display panel is impacted by the external force. In the embodiment, the materials of both the elastic buffer layer and the spacers are resin. The materials of both the elastic buffer layer and the spacers may be resin materials with good anti-pressure ability, for example, they may be resin materials such as polyacrylic resin or polyester resin, etc. In other embodiments, the materials of the elastic buffer layer and the materials of the spacers may be different.

In the embodiment, the end faces that the spacers 6 contact the first display substrate 2 and the second display substrate 3 are arcing structures.

### Embodiment 3

FIG. 3 shows a schematic structure diagram of a touch display panel according to embodiment 3. The touch display panel according to embodiment 3 is same as the touch display panel according to embodiment 2 in addition to the spacers. The description of the same parts is omitted here for brevity. As shown in FIG. 3, the end faces that the spacers 6 contact the first display substrate 2 are arcing structures.

### Embodiment 4

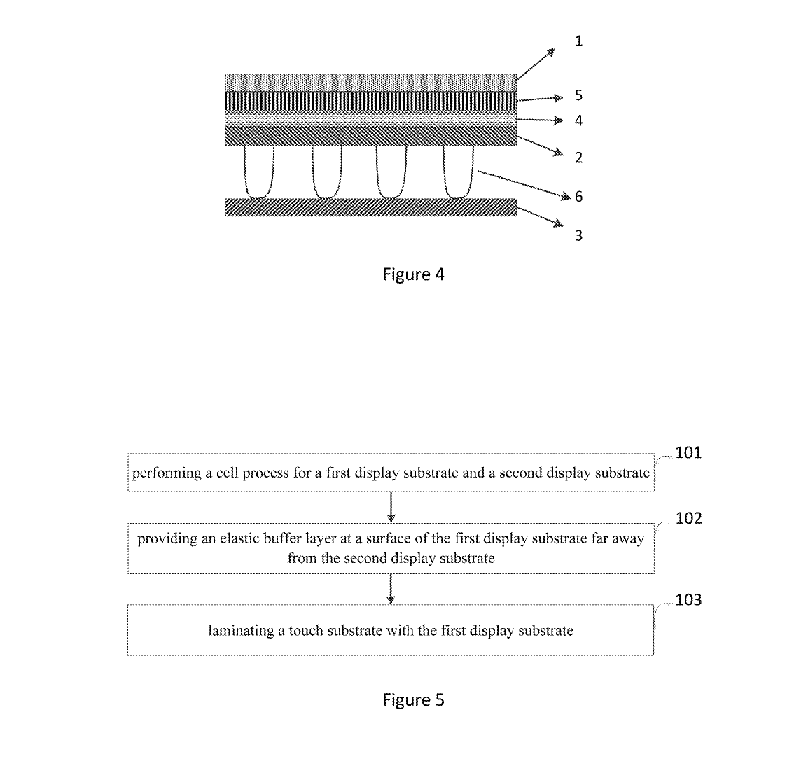

FIG. 4 shows a schematic structure diagram of a touch display panel according to embodiment 4. The touch display panel according to embodiment 4 is same as the touch display panels according to embodiments 2 and 3 in addition to the spacers. The description of the same parts is omitted here for brevity. As shown in FIG. 4, the spacers 6 are provided on the first display substrate 2, the spacers 6, and the first display substrate 2 are integrated together, and the end faces that the spacers 6 contact the second display substrate 3 are arcing structures.

According to embodiments 2-4, if the end faces that the spacers 6 contact the first display substrate 2 and/or the second display substrate 3 are arcing structures, then when the touch display panel is squeezed during use, there is a certain extrusion force between the first display substrate 2 and the second display substrate 3, the spacers 6 pressed by the extrusion force may be deformed. In this case, the arcing structure has a better elastic deformation ability and recovery ability comparing with a straight line shape or other shapes.

According to some embodiments, the first display substrate 2 is a color film substrate, the second display substrate 3 is an array substrate, and the color film substrate and the array substrate are arranged to form a cell.

According to various embodiments, the touch substrate 1 is a one-glass-solution touch substrate OGS.

In addition, the touch display panel according to embodiments of the disclosure may include any other suitable elements.

The touch display panel according to the embodiment can enhance greatly the anti-pressure ability of the touch display panel and increase the lifetime of the touch display panel by providing the elastic buffer layer between the first display substrate and the touch substrate such that when the touch display panel is pressed by the external force, the elastic buffer layer next to the touch substrate is pressed by the external force, the elastic buffer layer is deformed under the action of the external force, and the external force can be released, thereby avoiding or mitigating the impact of the external forces on the touch display panel.

### Embodiment 5

Embodiment 5 provides a touch display device including the touch display panel according to any one of the above embodiments.

Since the touch display device according to this embodiment includes the touch display panel according to any one of the above embodiments, the touch display device has a better anti-pressure ability and increases the lifetime of the touch display device.

In addition, the touch display device according to this embodiment may be applied to cellphone, tablet, video camera, camera, television, printer, etc.

### Embodiment 6

FIG. 5 is a flow chart of a method for fabricating a touch display panel according to embodiment 6. The method includes the following:

Step 101: performing a cell process for a first display substrate and a second display substrate.

Step 101 further includes providing spacers between the first display substrate and the second display substrate. In an embodiment, the end faces that the spacers contact the first display substrate and the second display substrate are arcing structures. In another embodiment, the spacers are provided on the second display substrate and the end faces that the spacers contact the first display substrate are arcing structures. In another embodiment, the spacers are provided on the first display substrate and the end faces that the spacers contact the second display substrate are arcing structures

If the end faces that the spacers contact the first display substrate and/or the second display substrate are arcing structures, then when the touch display panel is squeezed during use, there is an extrusion force between the first display substrate and the second display substrate, the spacers pressed by the extrusion force may be deformed. In this case, the arcing structure has a better elastic deformation ability and recovery ability comparing with a straight line shape or other shapes.

In addition, the first display substrate may be a color film substrate, the second display substrate may be an array substrate, and the color film substrate and the array substrate are arranged to form a cell.

Step 102: providing an elastic buffer layer at a surface of the first display substrate far away from the second display substrate.

For example, step 102 will be described by considering that the first display substrate is the color film substrate and the second display substrate is the array substrate.

The elastic buffer layer is provided on the surface of the color film substrate away from the array substrate before forming a color film substrate photo resist structure on the color film substrate, and the materials of the elastic buffer layer and the materials of the spacers as described in step 101 are the same or different.

The process of providing the elastic buffer layer may include coating the materials of the elastic buffer layer on the surface of the color film substrate far away from the array substrate. Preferably, the materials are resin materials with anti-pressure ability, for example, resin materials such as polyacrylic resin or polyester resin, etc.

Step 103: laminating the touch substrate with the first display substrate.

In this step, the first elastic buffer layer is provided on the first display substrate, optically clear adhesive (OCA) or optically clear resin (OCR) is coated on the surface of the elastic buffer layer, and then the touch substrate is laminated on it.

When the front of the touch display panel is acted by the external force, since the elastic buffer layer next to the touch substrate is pressed by the external force, the elastic buffer layer is deformed under the action of the external force, and then the external force can be released, therefore the impact of the external forces on the touch display panel can be avoided or mitigated, the anti-pressure ability of the touch display panel can be enhanced greatly and the lifetime of the touch display panel can be increased.

The implementations above are only for illustrating the embodiment of the disclosure rather than limiting the disclosure. Though the disclosure have been described in detail with reference to embodiments, it should be understood by those ordinary skilled in the art that modifications and equivalent replacements of the solution of the disclosure can be made without departing from the spirit and scope of the solution of the disclosure.

1. A touch display panel comprising:
a touch substrate:
a first display and substrate; and
a second display substrate, wherein the touch substrate, the first display substrate, and the second display substrate are sequentially arranged, and wherein an elastic buffer layer is located between the first display substrate and the touch substrate.

2. The touch display panel according to claim 1, wherein one of an optically clear adhesive layer and an optically clear resin layer is located between the touch substrate and the elastic buffer layer.

3. The touch display panel according to claim 1, wherein the elastic buffer layer is located on the first display substrate.

4. The touch display panel according to claim 1, wherein the materials of the elastic buffer layer are resin.

5. The touch display panel according to claim 1, wherein spacers are located between the first display substrate and the second display substrate, and wherein the materials of the elastic buffer layer and the materials of the spacers are the same.

6. The touch display panel according to claim 5, wherein end faces of the spacers that contact the first display substrate and the second display substrate are arcuate structures.

7. The touch display panel according to claim 5, wherein the spacers are located on the second display substrate, wherein the spacers and the second display substrate are integrated together, and wherein ends of the spacers that contact the first display substrate are arcuate structures.

8. The touch display panel according to claim 1, wherein the first display substrate is a color film substrate, wherein the second display substrate is an array substrate, and wherein the first display substrate and the second display substrate are arranged to form a cell.

9. The touch display panel according to claim 1, wherein the touch substrate is a one-glass-solution touch substrate.

10. A touch display device comprising the touch display panel according to claim 1.

11. A method for fabricating a touch display panel comprising:
performing a cell process for a first display substrate and a second display substrate;
providing an elastic buffer layer at a surface of the first display substrate opposite from the second display substrate; and
laminating a touch substrate with the first display substrate.

12. The method according to claim 11, wherein laminating the touch substrate with the first display substrate comprises one of coating optically clear adhesive and optically clear resin on a surface of the elastic buffer layer and then laminating the touch substrate on the coating.

13. The method according to claim 11, wherein providing an elastic buffer layer at a surface of the first display substrate opposite from the second display substrate comprises coating materials of the elastic buffer layer on the surface of the first display substrate opposite from the second display substrate.

14. The method according to claim 11, wherein the materials of the elastic buffer layer are resin.

15. The touch display panel according to claim 2, wherein the elastic buffer layer is located on the first display substrate.

16. The touch display panel according to claim 2, wherein the materials of the elastic buffer layer are resin.

17. The touch display panel according to claim 3, wherein the materials of the elastic buffer layer are resin.

18. The touch display panel according to claim 2, wherein spacers are located between the first display substrate and the second display substrate, and wherein the materials of the elastic buffer layer and the materials of the spacers are the same.

19. The touch display panel according to claim 3, wherein spacers are located between the first display substrate and the second display substrate, and wherein the materials of the elastic buffer layer and the materials of the spacers are the same.

20. The touch display panel according to claim 4, wherein spacers are located between the first display substrate and the second display substrate, and wherein the materials of the elastic buffer layer and the materials of the spacers are the same.
